(19) United States
(12) Patent Application Publication
(10) Pub. No.: US 2025/0341679 A1
(43) Pub. Date: Nov. 6, 2025

(54) Waveguides Incorporating Transmissive and Reflective Gratings and Related Methods of Manufacturing

(71) Applicant: DigiLens Inc., Sunnyvale, CA (US)

(72) Inventors: Jonathan David Waldern, Diablo, CA (US); Alastair John Grant, San Jose, CA (US); Hyesog Lee, Sunnyvale, CA (US); Gerald Buxton, Sunnyvale, CA (US); Milan Momcilo Popovich, Leicester (GB)

(73) Assignee: DigiLens Inc., Sunnyvale, CA (US)

(21) Appl. No.: 19/172,390

(22) Filed: Apr. 7, 2025

Related U.S. Application Data
(63) Continuation of application No. 18/362,870, filed on Jul. 31, 2023, now Pat. No. 12,271,035.
Application No. 18/362,870 is a continuation of application No. 17/410,828, filed on Aug. 24, 2021, now Pat. No. 11,747,568.
Application No. 17/410,828 is a continuation of application No. 16/895,856, filed on Jun. 8, 2020, now abandoned.
(60) Provisional application No. 62/858,928, filed on Jun. 7, 2019.

(51) Int. Cl. G02B 6/35; F21V 8/00; G02B 6/02; G02B 27/00

(52) U.S. Cl. CPC G02B 6/3522; G02B 6/0016; G02B 6/02076; G02B 6/02276; G02B 27/0081

(57) ABSTRACT

Multiplexed reflection and transmission gratings, and methods of their manufacture, are provided that improve uniformity with laser light, that is, reduced banding and other illumination artifacts occurring in waveguides. The mechanism for this can be the multiple reflections between the waveguide reflecting surfaces and the reflection hologram, which promote illumination averaging as beam propagation processes within a waveguide. In some gratings, a beam splitter layer overlapping the multiplexed gratings can be provided for the purposes of reducing banding in a laser-illuminated waveguide. The beam splitter can be provided by one or more dielectric layers. The beamsplitter can have sensitivity to one polarization. The beamsplitter can be sensitive to S-polarization. The beam splitter can be an anti-reflection coating optimized for normal incidence that becomes reflective at high TIR angles when immersed in glass or plastic.

### CROSS-REFERENCE TO RELATED APPLICATIONS

The current application is a continuation of U.S. patent application Ser. No. 18/362,870 entitled “Waveguides Incorporating Transmissive and Reflective Gratings and Related Methods of Manufacturing,” filed Jul. 31, 2023, which is a continuation of U.S. patent application Ser. No. 17/410,828 entitled “Waveguides Incorporating Transmissive and Reflective Gratings and Related Methods of Manufacturing,” filed Aug. 24, 2021, which is a continuation of U.S. patent application Ser. No. 16/895,856 entitled “Waveguides Incorporating Transmissive and Reflective Gratings and Related Methods of Manufacturing,” filed Jun. 8, 2020, which claims the benefit of and priority under 35 U.S.C. § 119 (e) to U.S. Provisional Patent Application No. 62/858,928 entitled “Single Grating Layer Color Holographic Waveguide Displays and Related Methods of Manufacturing,” filed Jun. 7, 2019, the disclosures of which are hereby incorporated by reference in their entireties.

### FIELD OF THE INVENTION

The present disclosure relates to waveguide devices and, more particularly, to holographic waveguide displays.

### BACKGROUND

Waveguides can be referred to as structures with the capability of confining and guiding waves (i.e., restricting the spatial region in which waves can propagate). One subclass includes optical waveguides, which are structures that can guide electromagnetic waves, typically those in the visible spectrum. Waveguide structures can be designed to control the propagation path of waves using a number of different mechanisms. For example, planar waveguides can be designed to utilize diffraction gratings to diffract and couple incident light into the waveguide structure such that the in-coupled light can proceed to travel within the planar structure via total internal reflection (TIR).

Fabrication of waveguides can include the use of material systems that allow for the recording of holographic optical elements within the waveguides. One class of such material includes polymer dispersed liquid crystal (PDLC) mixtures, which are mixtures containing photopolymerizable monomers and liquid crystals. A further subclass of such mixtures includes holographic polymer dispersed liquid crystal (HPDLC) mixtures. Holographic optical elements, such as volume phase gratings, can be recorded in such a liquid mixture by illuminating the material with two mutually coherent laser beams. During the recording process, the monomers polymerize, and the mixture undergoes a photopolymerization-induced phase separation, creating regions densely populated by liquid crystal micro-droplets, interspersed with regions of clear polymer. The alternating liquid crystal-rich and liquid crystal-depleted regions form the fringe planes of the grating. The resulting grating, which is commonly referred to as a switchable Bragg grating (SBG), has all the properties normally associated with volume or Bragg gratings but with much higher refractive index modulation ranges combined with the ability to electrically tune the grating over a continuous range of diffraction efficiency (the proportion of incident light diffracted into a desired direction). The latter can extend from non-diffracting (cleared) to diffracting with close to 100% efficiency.

Waveguide optics, such as those described above, can be considered for a range of display and sensor applications. In many applications, waveguides containing one or more grating layers encoding multiple optical functions can be realized using various waveguide architectures and material systems, enabling new innovations in near-eye displays for augmented reality (AR) and virtual reality (VR), compact head-up displays (HUDs) and helmet-mounted displays or head-mounted displays (HMDs) for road transport, aviation, and military applications, and sensors for biometric and laser radar (LIDAR) applications.

### SUMMARY OF THE INVENTION

Systems and methods for implementing holographic waveguide displays incorporating transmissive and reflective gratings in accordance with various embodiments of the invention are illustrated. One embodiment includes a waveguide display including a source of light modulated with image data and a waveguide including at least one transmission grating, at least one reflection grating, wherein the at least one reflection and the at least one transmission grating at least partially overlap, and at least one input coupler for coupling light from the source of light into a TIR path in the waveguide.

In another embodiment, the at least one reflection grating and the at least one transmission grating are multiplexed in a single grating layer.

In a further embodiment, the at least one input coupler is a grating.

In still another embodiment, the at least one input coupler includes an input transmission grating, the at least one transmission grating includes a fold transmission grating and an output transmission grating, and at least one of the input, fold, and output transmission gratings is multiplexed with the at least one reflection grating.

In a still further embodiment, the at least one input coupler includes an input transmission grating, the at least one transmission grating includes first and second fold transmission gratings, the at least one reflection grating overlaps at least one of the input transmission grating and the first and second fold transmission gratings, the first and second fold transmission gratings overlap each other, the first and second fold transmission gratings have crossed K-vectors, each of the fold transmission gratings is configured to beam-expand light from the input grating and couple it towards the other fold transmission grating, which then beam-expand and extract light towards a viewer.

In yet another embodiment, each of the gratings has a grating vector that in combination provide a resultant vector with substantially zero magnitude.

In a yet further embodiment, the light undergoes a dual interaction within at least one of the gratings.

In another additional embodiment, the waveguide display further includes a beam splitter layer overlapping the at least one reflection grating.

In a further additional embodiment, the waveguide display further includes an alignment layer overlapping the at least one reflection grating.

In another embodiment again, the source of data modulated light is one of a laser-scanning projector, a microdisplay panel, and/or an emissive display.

In a further embodiment again, the source of light provides at least two different wavelengths.

In still yet another embodiment, at least one of the gratings is characterized by a spatial variation of a property that is one of refractive index modulation, K-vector, grating vector, grating pitch, and/or birefringence.

In a still yet further embodiment, the gratings are configured to provide separate optical paths for a property that is one of wavelength band, angular bandwidth, and/or polarization state.

In still another additional embodiment, the waveguide is curved.

In a still further additional embodiment, the waveguide incorporates a GRIN structure.

In still another embodiment again, the waveguide is plastic.

In a still further embodiment again, at least one of the gratings includes a structure that is one of a switchable Bragg grating recorded in a holographic photopolymer a HPDLC material, a switchable Bragg grating recorded in a uniform modulation holographic liquid crystal polymer material, a Bragg grating recorded in a photopolymer material, and/or a surface relief grating.

A yet another additional embodiment includes a method of fabricating a holographic waveguide, the method including providing at least one light source, a layer of holographic recording material, and an at least partially reflective surface, forming first and second recording beams using the at least one light source, transmitting the first and second recording beams into the layer of holographic recording material, transmitting a portion of the first recording beam through the layer of holographic recording material towards the at least partially reflective surface, reflecting the transmitted portion of the first beam off the at least partially reflective surface back into the layer of holographic recording material, forming a transmission grating in the layer of holographic recording material using the first and second recording beams, and forming a reflection grating in the layer of holographic recording material using the reflected portion of the first recording beam and the second recording beam.

In a yet further additional embodiment, the method further includes forming a liquid crystal and polymer anchoring structure for supporting a reflection grating.

A yet another embodiment again includes a method of fabricating a holographic waveguide, the method including providing a master grating, a substrate supporting a layer of recording material, a source of light, and an at least partially reflective surface disposed opposite to the master grating with respect to the layer of recording material, illuminating the master grating with light from the source of light to form a diffracted beam and a zero-order beam, reflecting the diffracted beam from the at least partially reflective surface, forming a transmission grating from the zero-order beam and the diffracted beam, and forming a reflection grating from the zero-order beam and the reflected diffracted beam.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description will be more fully understood with reference to the following figures and data graphs, which are presented as exemplary embodiments of the invention and should not be construed as a complete recitation of the scope of the invention.

FIG. 1 conceptually illustrates a waveguide display implementing transmission and reflection gratings in accordance with an embodiment of the invention.

FIG. 2 conceptually illustrates a waveguide display having multiplexed transmission and reflection gratings in accordance with an embodiment of the invention.

FIG. 3 conceptually illustrates multiplexed transmission and reflection gratings in accordance with an embodiment of the invention.

FIG. 4 conceptually illustrates a system for recording a multiplexed transmission-reflection grating in accordance with an embodiment of the invention.

FIGS. 5 and 6 conceptually illustrate the formation of multiplexed transmission and reflection gratings in accordance with various embodiments of the invention.

FIGS. 7-9 show flow diagrams conceptually illustrating different methods of forming transmission and reflection gratings in accordance with various embodiments of the invention.

FIG. 10 conceptually illustrates a waveguide display architecture implementing multiplexed transmission and reflection fold gratings in accordance with an embodiment of the invention.

FIG. 11 conceptually illustrates a waveguide architecture implementing multiplexed transmission and reflection output gratings in accordance with an embodiment of the invention.

FIG. 12 conceptually illustrates a waveguide architecture implementing multiplexed transmission and reflection input gratings in accordance with an embodiment of the invention.

FIG. 13 conceptually illustrates a waveguide architecture implementing two separate input gratings in accordance with an embodiment of the invention.

FIG. 14 conceptually illustrates a waveguide architecture implementing crossed fold gratings in accordance with an embodiment of the invention.

FIG. 15 conceptually illustrates a waveguide architecture implementing crossed fold gratings in which the input coupler multiplexes transmission and reflection gratings in accordance with an embodiment of the invention.

FIG. 16 conceptually illustrates a waveguide architecture implementing crossed fold gratings in which two separate input gratings are provided in accordance with an embodiment of the invention.

FIG. 17 conceptually illustrates a profile view of a waveguide architecture in which overlapping transmission and reflection gratings are provided in accordance with an embodiment of the invention.

FIG. 18 shows a chart illustrating the diffraction efficiency versus incidence angle of a reflection grating and the diffraction efficiency angular bandwidth of a transmission grating in accordance with an embodiment of the invention.

FIG. 19 conceptually illustrates a profile view of a waveguide architecture in which a transmission grating and four reflection gratings are provided in accordance with an embodiment of the invention.

FIG. 20 shows a chart illustrating the diffraction efficiency versus incidence angle of a reflection grating, the effective angular bandwidth resulting from the two reflection gratings, and the diffraction efficiency angular bandwidth of the transmission grating in accordance with an embodiment of the invention.

### DETAILED DESCRIPTION

For the purposes of describing embodiments, some well-known features of optical technology known to those skilled in the art of optical design and visual displays have been omitted or simplified in order to not obscure the basic principles of the invention. Unless otherwise stated, the term “on-axis” in relation to a ray or a beam direction refers to propagation parallel to an axis normal to the surfaces of the optical components described in relation to the invention. In the following description the terms light, ray, beam, and direction may be used interchangeably and in association with each other to indicate the direction of propagation of electromagnetic radiation along rectilinear trajectories. The term light and illumination may be used in relation to the visible and infrared bands of the electromagnetic spectrum. Parts of the following description will be presented using terminology commonly employed by those skilled in the art of optical design. As used herein, the term grating may encompass a grating having a set of gratings in some embodiments. For illustrative purposes, it is to be understood that the drawings are not drawn to scale unless stated otherwise.

Waveguide technology can enable low cost, efficient, and versatile diffractive optical solutions for many different applications. In many embodiments, a waveguide display supporting at least one transmission grating and at least one reflection grating is implemented. The transmission and reflection gratings can be implemented across different grating layers or within a single grating layer. In some embodiments, the transmission and reflection gratings are multiplexed. A multiplexed transmission and reflection grating can be configured for the specific purpose of supporting transmission gratings at angles that otherwise could not be supported in typical Bragg gratings. In several embodiments, such structures can be used to make high efficiency reflection input gratings for use in waveguides.

In many embodiments, multiplexed reflection and transmission gratings can provide improved uniformity with laser light, that is, reduced banding and other illumination artifacts occurring in waveguides. The mechanism for this can be the multiple reflections between the waveguide reflecting surfaces and the reflection hologram, which promote illumination averaging as beam propagation processes within a waveguide. In some embodiments, a beam splitter layer overlapping the multiplexed gratings can be provided for the purposes of reducing banding in a laser-illuminated waveguide. The beam splitter can be provided by one or more dielectric layers. In several embodiments, the beamsplitter can have sensitivity to one polarization. In further embodiments, the beamsplitter can be sensitive to S-polarization. In a number of embodiments, the beam splitter can be an anti-reflection coating optimized for normal incidence that becomes reflective at high TIR angles when immersed in glass or plastic.

Various systems and methods can be implemented to fabricate waveguides incorporating transmissive and reflective gratings. In many embodiments, a system for fabricating such gratings can include at least one source of light, a master grating providing a zero-order beam and at least one diffracted order beam from the light, a substrate supporting a layer of holographic recording material (such as but not limited to HPDLC materials) overlapping the master, and an at least partially reflective surface overlapping the holographic recording material layer. During the recording operation, the diffracted beam can be reflected by the at least partially reflective surface. Through a combination of interference from the zero-order beam, the diffracted beam, and the reflected beam, both transmission and reflection gratings can be recorded. In many embodiments, the transmission and reflection gratings are multiplexed. In some embodiments, the system includes an HPDLC mixture that includes a weak dielectric material that enables efficient multiplexing of reflection and transmission gratings without generating unwanted reflections (and hence spurious gratings). In several embodiments, overlaid alignment layers may be used to fine tune HPDLC multiplexed reflection and transmission grating formation. For example, in some embodiments, selective alignment of HPDLC gratings can be used to balance the refractive index modulations and or the polarization response of the multiplexed transmission and reflection gratings. In a number of embodiments, alignment layers may be used to promote S-polarization sensitivity in the reflection grating. In a typical waveguide implementation, the average extraordinary axis of the LC rich fringes (which in typical HPDLC gratings will be orthogonal to the Bragg fringe plane) will be normal to the waveguide reflecting surfaces. This orientation can be advantageous for providing strong interaction with light propagating through a fold grating at typical waveguide total internal reflection angles.

Waveguide embodiments implementing transmission and reflection gratings can be utilized and configured for a variety of applications. For example, in some applications, it is desirable for the waveguide to be compact and wide angle with a generous eyebox while also providing full color. Previous solutions to color imaging have include stacking two or more monochrome waveguides, where each waveguide supports a grating layer with gratings configured to operate in a single color. In many cases, each waveguide is further configured for inputting image modulated light, expanding the light in two dimensions, and extracting it from the waveguide towards an eye box. However, such multi-waveguide stacking solutions suffer from the tight tolerances required to align the overlapping gratings in the waveguide stack, which can result in low manufacturing yield. Two-layer solutions in which one layer propagates red light and the second layer propagate light in the green-blue band have been attempted but still present alignment problems in manufacturing. As such, many embodiments of the invention are directed towards methods and architectures for implementing wide-angle, single grating layer color waveguide displays. Waveguide and grating architectures, holographic recording materials, and waveguide embodiments incorporating transmission and reflection gratings are discussed in the sections below in further detail.

### Optical Waveguide and Grating Structures

Optical structures recorded in waveguides can include many different types of optical elements, such as but not limited to diffraction gratings. Gratings can be implemented to perform various optical functions, including but not limited to coupling light, directing light, and preventing the transmission of light. In many embodiments, the gratings are surface relief gratings that reside on the outer surface of the waveguide. In other embodiments, the grating implemented is a Bragg grating (also referred to as a volume grating), which are structures having a periodic refractive index modulation. Bragg gratings can be fabricated using a variety of different methods. One process includes interferential exposure of holographic photopolymer materials to form periodic structures. Bragg gratings can have high efficiency with little light being diffracted into higher orders. The relative amount of light in the diffracted and zero order can be varied by controlling the refractive index modulation of the grating, a property that can be used to make lossy waveguide gratings for extracting light over a large pupil. A grating can be characterized by a grating vector defining the orientation of the grating fringes in the plane of the waveguide. A grating can also be characterized by a K-vector in 3D space, which in the case of a Bragg grating is defined as the vector normal to the Bragg fringes. The K-vector vector can determine the optical efficiency for a given range of input and diffracted angles.

One class of Bragg gratings used in holographic waveguide devices is the Switchable Bragg Grating (SBG). SBGs can be fabricated by first placing a thin film of a mixture of photopolymerizable monomers and liquid crystal material between substrates. The substrates can be made of various types of materials, such glass and plastics. In many cases, the substrates are in a parallel configuration. In other embodiments, the substrates form a wedge shape. One or both substrates can support electrodes, typically transparent tin oxide films, for applying an electric field across the film. The grating structure in an SBG can be recorded in the liquid material (often referred to as the syrup) through photopolymerization-induced phase separation using interferential exposure with a spatially periodic intensity modulation. Factors such as but not limited to control of the irradiation intensity, component volume fractions of the materials in the mixture, and exposure temperature can determine the resulting grating morphology and performance. As can readily be appreciated, a wide variety of materials and mixtures can be used depending on the specific requirements of a given application. In many embodiments, HPDLC material is used. During the recording process, the monomers polymerize, and the mixture undergoes a phase separation. The LC molecules aggregate to form discrete or coalesced droplets that are periodically distributed in polymer networks on the scale of optical wavelengths. The alternating liquid crystal-rich and liquid crystal-depleted regions form the fringe planes of the grating, which can produce Bragg diffraction with a strong optical polarization resulting from the orientation ordering of the LC molecules in the droplets.

The resulting volume phase grating can exhibit very high diffraction efficiency, which can be controlled by the magnitude of the electric field applied across the film. When an electric field is applied to the grating via transparent electrodes, the natural orientation of the LC droplets can change, causing the refractive index modulation of the fringes to lower and the hologram diffraction efficiency to drop to very low levels. Typically, the electrodes are configured such that the applied electric field will be perpendicular to the substrates. In a number of embodiments, the electrodes are fabricated from indium tin oxide (ITO). In the OFF state with no electric field applied, the extraordinary axis of the liquid crystals generally aligns normal to the fringes. The grating thus exhibits high refractive index modulation and high diffraction efficiency for P-polarized light. When an electric field is applied to the HPDLC, the grating switches to the ON state wherein the extraordinary axes of the liquid crystal molecules align parallel to the applied field and hence perpendicular to the substrate. In the ON state, the grating exhibits lower refractive index modulation and lower diffraction efficiency for both S- and P-polarized light. Thus, the grating region no longer diffracts light. Each grating region can be divided into a multiplicity of grating elements such as for example a pixel matrix according to the function of the HPDLC device. Typically, the electrode on one substrate surface is uniform and continuous, while electrodes on the opposing substrate surface are patterned in accordance to the multiplicity of selectively switchable grating elements.

Typically, the SBG elements are switched clear in 30 us with a longer relaxation time to switch ON. The diffraction efficiency of the device can be adjusted, by means of the applied voltage, over a continuous range. In many cases, the device exhibits near 100% efficiency with no voltage applied and essentially zero efficiency with a sufficiently high voltage applied. In certain types of HPDLC devices, magnetic fields can be used to control the LC orientation. In some HPDLC applications, phase separation of the LC material from the polymer can be accomplished to such a degree that no discernible droplet structure results. An SBG can also be used as a passive grating. In this mode, its chief benefit is a uniquely high refractive index modulation. SBGs can be used to provide transmission or reflection gratings for free space applications. SBGs can be implemented as waveguide devices in which the HPDLC forms either the waveguide core or an evanescently coupled layer in proximity to the waveguide. The substrates used to form the HPDLC cell provide a total internal reflection (TIR) light guiding structure. Light can be coupled out of the SBG when the switchable grating diffracts the light at an angle beyond the TIR condition.

In some embodiments, LC can be extracted or evacuated from the SBG to provide an evacuated Bragg grating (EBG). EBGs can be characterized as a surface relief grating (SRG) that has properties very similar to a Bragg grating due to the depth of the SRG structure (which is much greater than that practically achievable using surface etching and other conventional processes commonly used to fabricate SRGs). The LC can be extracted using a variety of different methods, including but not limited to flushing with isopropyl alcohol and solvents. In many embodiments, one of the transparent substrates of the SBG is removed, and the LC is extracted. In further embodiments, the removed substrate is replaced. The SRG can be at least partially backfilled with a material of higher or lower refractive index. Such gratings offer scope for tailoring the efficiency, angular/spectral response, polarization, and other properties to suit various waveguide applications.

Waveguides in accordance with various embodiments of the invention can include various grating configurations designed for specific purposes and functions. In many embodiments, the waveguide is designed to implement a grating configuration capable of preserving eyebox size while reducing lens size by effectively expanding the exit pupil of a collimating optical system. The exit pupil can be defined as a virtual aperture where only the light rays which pass though this virtual aperture can enter the eyes of a user. In some embodiments, the waveguide includes an input grating optically coupled to a light source, a fold grating for providing a first direction beam expansion, and an output grating for providing beam expansion in a second direction, which is typically orthogonal to the first direction, and beam extraction towards the eyebox. As can readily be appreciated, the grating configuration implemented waveguide architectures can depend on the specific requirements of a given application. In many embodiments, the gratings used in any of the embodiments can have grating vectors matched to provide a resultant vector with substantially zero magnitude. In some embodiments, the grating configuration includes multiple fold gratings. In several embodiments, the grating configuration includes an input grating and a second grating for performing beam expansion and beam extraction simultaneously. The second grating can include gratings of different prescriptions, for propagating different portions of the field-of-view, arranged in separate overlapping grating layers or multiplexed in a single grating layer. In a number of embodiments, two grating layers are disposed on either side of a single substrate layer. Furthermore, various types of gratings and waveguide architectures can also be utilized.

In several embodiments, the gratings within each layer are designed to have different spectral and/or angular responses. For example, in many embodiments, different gratings across different grating layers are overlapped, or multiplexed, to provide an increase in spectral bandwidth. In some embodiments, a full color waveguide is implemented using three grating layers, each designed to operate in a different spectral band (red, green, and blue). In other embodiments, a full color waveguide is implemented using two grating layers, a red-green grating layer and a green-blue grating layer. As can readily be appreciated, such techniques can be implemented similarly for increasing angular bandwidth operation of the waveguide. In addition to the multiplexing of gratings across different grating layers, multiple gratings can be multiplexed within a single grating layer—i.e., multiple gratings can be superimposed within the same volume. In several embodiments, the waveguide includes at least one grating layer having two or more grating prescriptions multiplexed in the same volume. In further embodiments, the waveguide includes two grating layers, each layer having two grating prescriptions multiplexed in the same volume. Multiplexing two or more grating prescriptions within the same volume can be achieved using various fabrication techniques. In a number of embodiments, a multiplexed master grating is utilized with an exposure configuration to form a multiplexed grating. In many embodiments, a multiplexed grating is fabricated by sequentially exposing an optical recording material layer with two or more configurations of exposure light, where each configuration is designed to form a grating prescription. In some embodiments, a multiplexed grating is fabricated by exposing an optical recording material layer by alternating between or among two or more configurations of exposure light, where each configuration is designed to form a grating prescription. As can readily be appreciated, various techniques, including those well known in the art, can be used as appropriate to fabricate multiplexed gratings.

In some embodiments, the light propagating within a waveguide in accordance with an embodiment of the invention can undergo a dual interaction within at least one of the gratings (i.e., the grating is designed to have high diffraction efficiency, or diffraction efficiency peaks, for two different incidence angles). In many embodiments, the waveguide can incorporate at least one of: angle multiplexed gratings, color multiplexed gratings, fold gratings, dual interaction gratings, rolled K-vector gratings, crossed fold gratings, tessellated gratings, chirped gratings, gratings with spatially varying refractive index modulation, gratings having spatially varying grating thickness, gratings having spatially varying average refractive index, gratings with spatially varying refractive index modulation tensors, gratings having spatially varying average refractive index tensors, and gratings having spatially varying birefringence properties. In some embodiments, the waveguide can incorporate at least one of: a half wave plate, a quarter wave plate, an anti-reflection coating, a beam splitting layer, an alignment layer, a photochromic back layer for glare reduction, and louvre films for glare reduction. In several embodiments, the waveguide can support gratings providing separate optical paths for different polarizations. In various embodiments, the waveguide can support gratings providing separate optical paths for different spectral and/or angular bandwidths. In a number of embodiments, the gratings can be HPDLC gratings, switching gratings recorded in HPDLC (such switchable Bragg Gratings), Bragg gratings recorded in holographic photopolymer, or surface relief gratings. In many embodiments, the waveguide operates in a monochrome band. In some embodiments, the waveguide operates in the green band. In several embodiments, waveguide layers operating in different spectral bands such as red, green, and blue (RGB) can be stacked to provide a three-layer waveguiding structure. In further embodiments, the layers are stacked with air gaps between the waveguide layers. In various embodiments, the waveguide layers operate in broader bands such as blue-green and green-red to provide two-waveguide layer solutions. In other embodiments, the gratings are color multiplexed to reduce the number of grating layers. Various types of gratings can be implemented. In some embodiments, at least one grating in each layer is a switchable grating. In many embodiments, the waveguide can be curved. In several embodiments, the waveguide can incorporate a gradient index (GRIN) structure. In a number of embodiments, the waveguide can be fabricated using plastic substrates.

Waveguides incorporating optical structures such as those discussed above can be implemented in a variety of different applications, including but not limited to waveguide displays. In various embodiments, the waveguide display is implemented with an eyebox of greater than 10 mm with an eye relief greater than 25 mm. In some embodiments, the waveguide display includes a waveguide with a thickness between 2.0-5.0 mm. In many embodiments, the waveguide display can provide an image field-of-view of at least 50° diagonal. In further embodiments, the waveguide display can provide an image field-of-view of at least 70° diagonal. The waveguide display can employ many different types of picture generation units (PGUs). In several embodiments, the PGU can be a reflective or transmissive spatial light modulator such as a liquid crystal on Silicon (LCoS) panel or a micro electromechanical system (MEMS) panel. In a number of embodiments, the PGU can be an emissive device such as an organic light emitting diode (OLED) panel. In some embodiments, an OLED display can have a luminance greater than 4000 nits and a resolution of 4 k×4 k pixels. In several embodiments, the waveguide can have an optical efficiency greater than 10% such that a greater than 400 nit image luminance can be provided using an OLED display of luminance 4000 nits. Waveguides implementing P-diffracting gratings (i.e., gratings with high efficiency for P-polarized light) typically have a waveguide efficiency of 5%-6.2%. Since P-diffracting or S-diffracting gratings can waste half of the light from an unpolarized source such as an OLED panel, many embodiments are directed towards waveguides capable of providing both S-diffracting and P-diffracting gratings to allow for an increase in the efficiency of the waveguide by up to a factor of two. In some embodiments, the S-diffracting and P-diffracting gratings are implemented in separate overlapping grating layers. Alternatively, a single grating can, under certain conditions, provide high efficiency for both p-polarized and s-polarized light. In several embodiments, the waveguide includes Bragg-like gratings produced by extracting LC from HPDLC gratings, such as those described above, to enable high S and P diffraction efficiency over certain wavelength and angle ranges for suitably chosen values of grating thickness (typically, in the range 2-5 μm).

### Optical Recording Material Systems

HPDLC mixtures generally include LC, monomers, photoinitiator dyes, and coinitiators. The mixture (often referred to as syrup) frequently also includes a surfactant. For the purposes of describing the invention, a surfactant is defined as any chemical agent that lowers the surface tension of the total liquid mixture. The use of surfactants in PDLC mixtures is known and dates back to the earliest investigations of PDLCs. For example, a paper by R. L Sutherland et al., SPIE Vol. 2689, 158-169, 1996, the disclosure of which is incorporated herein by reference, describes a PDLC mixture including a monomer, photoinitiator, coinitiator, chain extender, and LCs to which a surfactant can be added. Surfactants are also mentioned in a paper by Natarajan et al, Journal of Nonlinear Optical Physics and Materials, Vol. 5 No. I 89-98, 1996, the disclosure of which is incorporated herein by reference. Furthermore, U.S. Pat. No. 7,018,563 by Sutherland; et al., discusses polymer-dispersed liquid crystal material for forming a polymer-dispersed liquid crystal optical element having: at least one acrylic acid monomer; at least one type of liquid crystal material; a photoinitiator dye; a coinitiator; and a surfactant. The disclosure of U.S. Pat. No. 7,018,563 is hereby incorporated by reference in its entirety.

The patent and scientific literature contains many examples of material systems and processes that can be used to fabricate SBGs, including investigations into formulating such material systems for achieving high diffraction efficiency, fast response time, low drive voltage, and so forth. U.S. Pat. No. 5,942,157 by Sutherland, and U.S. Pat. No. 5,751,452 by Tanaka et al. both describe monomer and liquid crystal material combinations suitable for fabricating SBG devices. Examples of recipes can also be found in papers dating back to the early 1990s. Many of these materials use acrylate monomers, including:
R. L. Sutherland et al., Chem. Mater. 5, 1533 (1993), the disclosure of which is incorporated herein by reference, describes the use of acrylate polymers and surfactants. Specifically, the recipe includes a crosslinking multifunctional acrylate monomer; a chain extender N-vinyl pyrrolidinone, LC E7, photo-initiator rose Bengal, and coinitiator N-phenyl glycine. Surfactant octanoic acid was added in certain variants.
Fontecchio et al., SID 00 Digest 774-776, 2000, the disclosure of which is incorporated herein by reference, describes a UV curable HPDLC for reflective display applications including a multi-functional acrylate monomer, LC, a photoinitiator, a coinitiators, and a chain terminator.
Y. H. Cho, et al., Polymer International, 48, 1085-1090, 1999, the disclosure of which is incorporated herein by reference, discloses HPDLC recipes including acrylates.
Karasawa et al., Japanese Journal of Applied Physics, Vol. 36, 6388-6392, 1997, the disclosure of which is incorporated herein by reference, describes acrylates of various functional orders.
T. J. Bunning et al., Polymer Science: Part B: Polymer Physics, Vol. 35, 2825-2833, 1997, the disclosure of which is incorporated herein by reference, also describes multifunctional acrylate monomers.
G. S. Iannacchione et al., Europhysics Letters Vol. 36 (6). 425-430, 1996, the disclosure of which is incorporated herein by reference, describes a PDLC mixture including a penta-acrylate monomer, LC, chain extender, coinitiators, and photoinitiator.

Acrylates offer the benefits of fast kinetics, good mixing with other materials, and compatibility with film forming processes. Since acrylates are cross-linked, they tend to be mechanically robust and flexible. For example, urethane acrylates of functionality 2 (di) and 3 (tri) have been used extensively for HPDLC technology. Higher functionality materials such as penta and hex functional stems have also been used.

### Waveguides Incorporating Reflection and Transmission Gratings

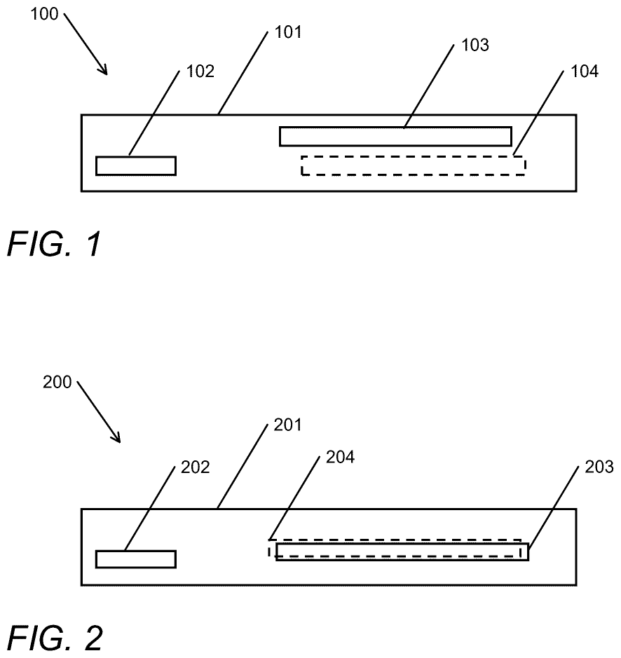

Referring generally to the drawings, systems and methods relating to displays or sensors implementing full color in a single grating layer in accordance with various embodiments of the invention are illustrated. In many embodiments, a waveguide display according to the principles of the invention includes at least one waveguide substrate, a source of light modulated with image data, at least one input coupler for coupling the light into TIR in waveguide, at least one transmission grating, and at least one reflection grating, where the reflection and the transmission grating at least partially overlap. FIG. 1 conceptually illustrates a waveguide display implementing transmission and reflection gratings in accordance with an embodiment of the invention. As shown, the display 100 includes a waveguide 101 supporting an input grating 102 providing the functions of an input coupler, a transmission grating 103, and a reflection grating 104. In the illustrative embodiment, the transmission grating 103 and the reflection grating 104 at least partially overlap. In some embodiments, the reflection grating and the transmission gratings can be multiplexed in a single grating layer. FIG. 2 conceptually illustrates such a waveguide. In FIG. 2, the display 200 shown includes a waveguide 201 supporting an input grating 202 and multiplexed transmission 203 and reflection gratings 204. Although FIGS. 1 and 2 illustrate specific waveguide structures, various configurations and modifications can be implemented in accordance with various embodiments of the invention. For example, in several embodiments, a prism is utilized instead of a grating as the input coupler. As discussed above, such waveguide displays can include at least one light source. In some embodiments, the light source provides image modulated light. In a number of embodiments, the source of data modulated light can include at least one of: a laser-scanning projector, a microdisplay panel, and/or an emissive display. In several embodiments, the source of data modulated light can provide at least two different wavelengths of light.

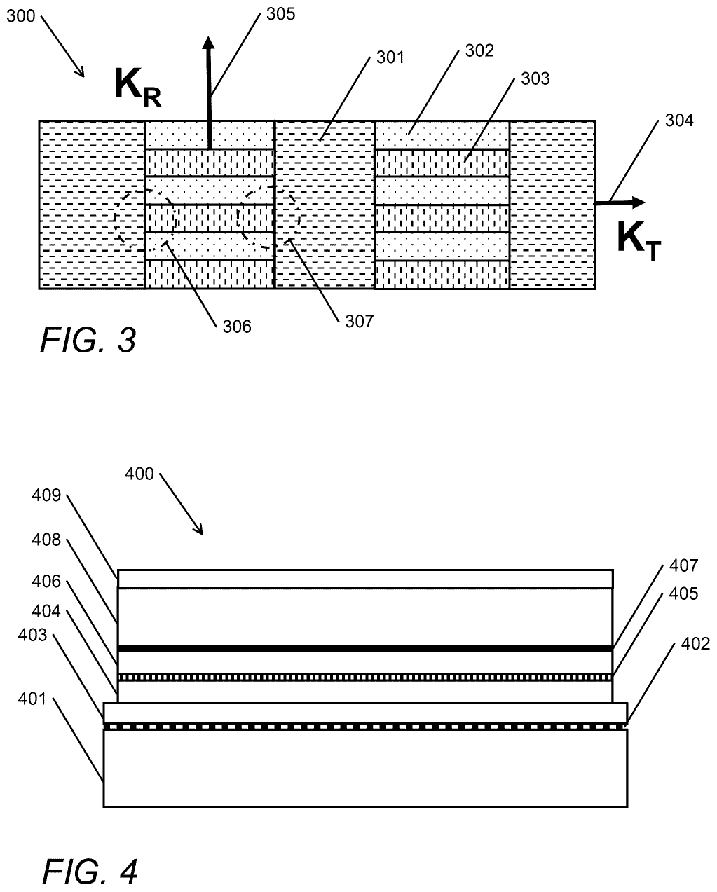

FIG. 3 conceptually illustrates multiplexed transmission and reflection gratings in accordance with an embodiment of the invention. As shown, the multiplexed grating 300 includes a transmission grating having fringes 301 separated by regions containing reflection gratings characterized by low refractive index 302 and high refractive index fringes 303. In many embodiments, the fringes 301 of the transmission grating can have an index greater than the average index of the reflection grating. In other embodiments, the fringes 301 of the transmission grating can have an index less than the average index of the reflection grating. In some embodiments, the index values are selected for producing various index contrasts between the transmission and reflection grating fringes. In the embodiment illustrated in FIG. 3, the reflection and transmission fringes are unslanted with transmission grating K-vectors 304 (labelled by symbol K_{T}) and reflection grating K-vectors 305 (labelled by symbol K_{R}) disposed orthogonally to each other. As can readily be appreciated, other embodiments can include architectures where one or both of the transmission and reflection gratings have slanted fringes.

The gratings as described above and throughout this disclosure can include various grating structures, including but not limited to volume gratings and surface relief gratings. In many embodiments, at least one of the gratings is recorded in a holographic photopolymer, an HPDLC material, or a uniform modulation holographic liquid crystal polymer material. Reflection gratings recorded in HPDLC materials can suffer from the problem that the resulting Bragg fringes tend to be very long and exhibit poor surface anchoring. In some cases, this can lead to delamination of the grating structure. In embodiments using HPDLCs (such as the one in FIG. 4), a liquid crystal and polymer anchoring structure (306, 307) that allows a reflection grating to be supported by the fringes of the transmission can be provided. In many embodiments, the anchoring strength can be controlled by selecting LCs and monomers types and by mixing the LC and monomers in concentrations that promote robust local anchoring between LC and polymer. In some embodiments, strong anchoring can be achieved by additives. The term “scaffolding” can be used to describe the use of one grating to support the other's formation. Relevant data and teachings on the chemistry and processes for promoting efficient anchoring can be found in the literature of HPDLC material systems.

Multiplexed gratings, such as the one shown in FIG. 2, can be fabricated in many different ways. As can readily be appreciated, the specific type of multiplexed gratings to be formed can dictate the method utilized. FIG. 4 conceptually illustrates a system for recording a multiplexed transmission-reflection grating in accordance with an embodiment of the invention. As shown, the recording apparatus 400 includes the following: a master grating substrate 401, a master grating 402, a master cover glass 403, a grating bottom substrate 404, a grating layer 405 of holographic recording material, a grating top substrate 406, a partially reflective layer 407 formed on a lower face of a substrate 408, and a filter glass substrate 409. As can readily be appreciated, each layer can be implemented with various types of materials having various thicknesses. For example, the master grating 402 can be an amplitude grating or a volume grating. The master cover glass 403 can be implemented with ˜1.1 mm thickness optical glass. In other embodiments, different glass thicknesses and materials can be used. The grating substrate layers 404, 406 can be Corning Iris™ glass, which typically ranges from ˜0.2 mm to ˜1.8 mm in thickness. In many embodiments, the grating layer 405 is on the order of micrometers, which can range from ˜1 μm to ˜5 μm in thickness. However, other grating layer thicknesses can be used as appropriate depending on the application. In some embodiments, the grating layer 405 is configured with a specific thickness to achieve specific grating angular bandwidth and efficiencies. The recording material of the grating layer 405 can be used to record gratings of any type, including slanted and non-slanted gratings. Such gratings can also be configured for providing various optical functions, including but not limited to coupling light into the waveguide, providing beam expansion, and extracting light from the waveguide. In a number of embodiments, the partially reflective coating 407 can be an antireflection coating that provides appreciable reflection at high incidence angles when immersed in glass. In some embodiments, the partially reflective coating 407 can be provided by one or more dielectric layers or by a stack comprising dielectric/metal layers. The partially reflective coating glass substrate 408 can be Corning® EAGLE XG® Slim Glass, and the filter glass substrate 409 can be Schott R60 blocker glass.

During the recording process, the master grating 402 can be illuminated to form zero-order and diffracted light. At least a portion of the zero-order light and at least a portion of the diffracted light can together form an interference pattern within the holographic recording material layer 405 to form a transmission grating. At least a portion of the zero-order light can be reflected from the partially reflecting coating 407 and interferes with at least a portion of the diffracted light within the holographic recording material 405 to form a reflection grating. The reflection and transmission gratings can be formed in a single multiplexed layer. As can readily be appreciated, in some embodiments, multiple grating layers are utilized to form overlapping transmission and reflection gratings

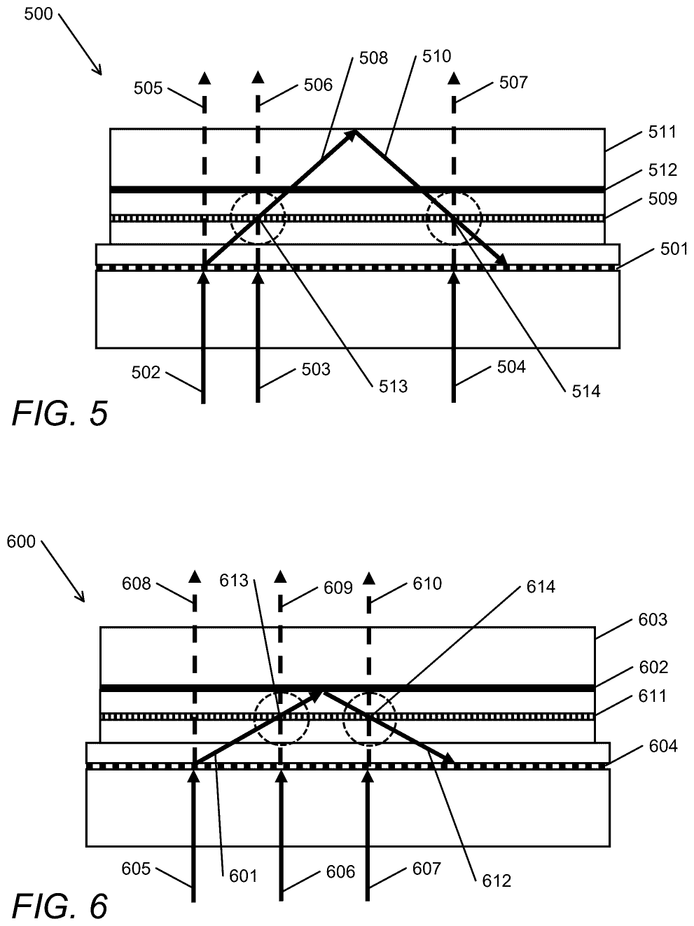

FIG. 5 conceptually illustrates the formation of multiplexed transmission and reflection gratings in accordance with an embodiment of the invention. The recording system 500 is similar to the system of FIG. 4. Similar to FIG. 4, the recording system 500 can also include a filter glass substrate. As shown, the master grating 501 is illuminated by incident collimated light represented by rays 502-504. The master grating 501 produces zero order light rays 505-507 and diffracted light ray 508. The zero order light rays 505-507 passes through a grating layer 509. A portion of the diffracted light 508 is reflected (510) off the upper surface of the top substrate 511 and re-interacts with the grating layer 509. In the illustrative embodiment, the system 500 includes a partially reflecting layer 512. In other embodiments, this layer is excluded. Referring back to FIG. 5, the reflection from the partially reflecting layer 512 is substantially weaker than that from the upper surface of the top substrate 511. As to the formation of the gratings, this configuration and arrangement of illumination and light paths allow for he zero-order light and diffracted light can interfere to form a transmission grating. For example, zero order rays 506 can interfere with the diffracted rays 508 to form a transmission grating in one portion 513 of the grating layer. Concurrently, the reflected diffracted rays 510 can interfere with zero order rays 507 to form a reflected grating in another portion 514 of the grating layer. As can readily be appreciated, the schematic shown in FIG. 5 does not illustrate every single light ray and interference interaction in the system. From consideration of the ray paths illustrated in FIG. 5, it should be apparent that transmission and reflection gratings can be multiplexed at each point across the grating layer. In some embodiments, the master grating 501 can be illuminated (sequentially or simultaneously) by more than one incident collimated beam to enable the recording of multiple sets of multiplexed reflection and transmission gratings. In several embodiments, the master 501 can be illuminated with beams having different incident angles at different points over the aperture of the master. In a number of embodiments, the master 501 can be illuminated by a scanned collimated beam. In some embodiments, the master 501 can be illuminated by a collimated beam that is directed at the master in a stepwise fashion across the aperture of the master.

FIG. 6 conceptually illustrates another configuration for forming a multiplexed transmission-reflection grating in accordance with an embodiment of the invention. Again, the recording system 600 is similar to the system shown in FIG. 4. Similar to FIG. 4, the recording system 600 can also include a filter glass substrate. In contrast to the embodiment of FIG. 5, diffracted light 601 in this case undergoes a reflection at the partially reflecting layer 602, the reflection at the upper surface of the top substrate 603 being substantially smaller. As shown, the master grating 604 is illuminated by incident collimated light represented by the rays 605-607. The master grating 604 produces zero order 608-610 light, which passes through the grating layer 611, and the diffracted light 601. A portion of the diffracted light 601 is reflected 612 off the partially reflecting layer 602 and re-interacts with the grating layer 611. The zero-order light and diffracted light can interfere to form a transmission grating and/or a reflection grating. For example, zero order light rays 609 interfere with the diffracted rays 601 to form a transmission grating in one portion 613 of the grating layer, while reflected diffracted rays 612 interfere with zero order rays 610 to form a reflection grating in another portion 614 of the grating layer 611.

Although FIGS. 5 and 6 illustrate specific methods and configurations of recording transmission and reflection gratings, various other processes can be implemented as appropriate depending on the specific requirements of a given application. In many embodiments, multiple grating layers are utilized, and the transmission and reflection gratings are not multiplexed. The multiple grating layers can be adjacent. In some embodiments, two grating layers are disposed on either side of a single substrate layer. In addition to different recording and exposure setup, various different processes can also be implemented.

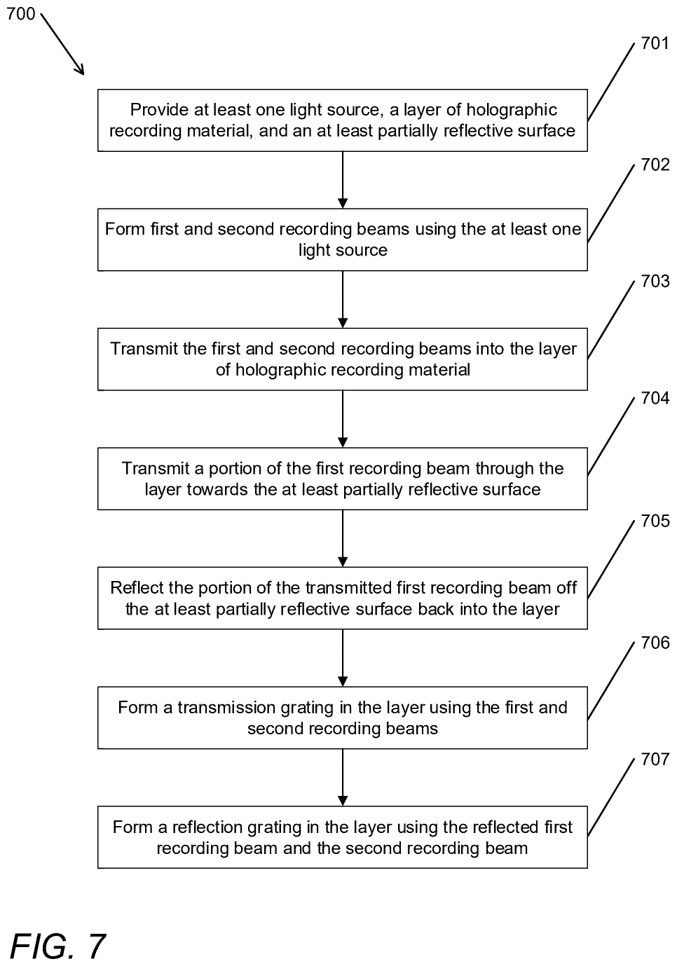

FIG. 7 shows a flow diagram conceptually illustrating a method of fabricating transmission and reflection gratings in accordance with an embodiment of the invention. As shown, the method 700 includes providing (701) at least one light source, a layer of holographic recording material, and an at least partially reflective surface. As can readily be appreciated, any of a variety of holographic recording material including but not limited to HPDLC materials and various photopolymers can be utilized as appropriate. In a number of embodiments, the reflective surface is a fully reflective surface. First and second recording beams can be formed (702) using the at least one light source. In many embodiments, a single light source is utilized to the form the first and second recording beams. For example, the two beams can be formed by directing a single beam from the light source towards a diffraction grating. In other embodiments, two light sources are utilized to respectively form the first and second recording beams. The first and second recording beams can be transmitted (703) into the layer of holographic recording material. A portion of the first recording beam can be transmitted (704) through the layer of holographic recording material towards the at least partially reflective surface. The portion of transmitted first recording beam can be reflected (705) off the at least partially reflective surface back into the layer of holographic recording material. A transmission grating can be formed (706) in the layer of holographic recording material using the first and second recording beams. A reflection grating can be formed (707) in the layer of holographic recording material using the reflected first recording beam and the second recording beam. In some embodiments, the at least partially reflective surface can form part of the finished waveguide component. In several embodiments, the at least partially reflective surface (and its supporting substrate) is only present during exposure.

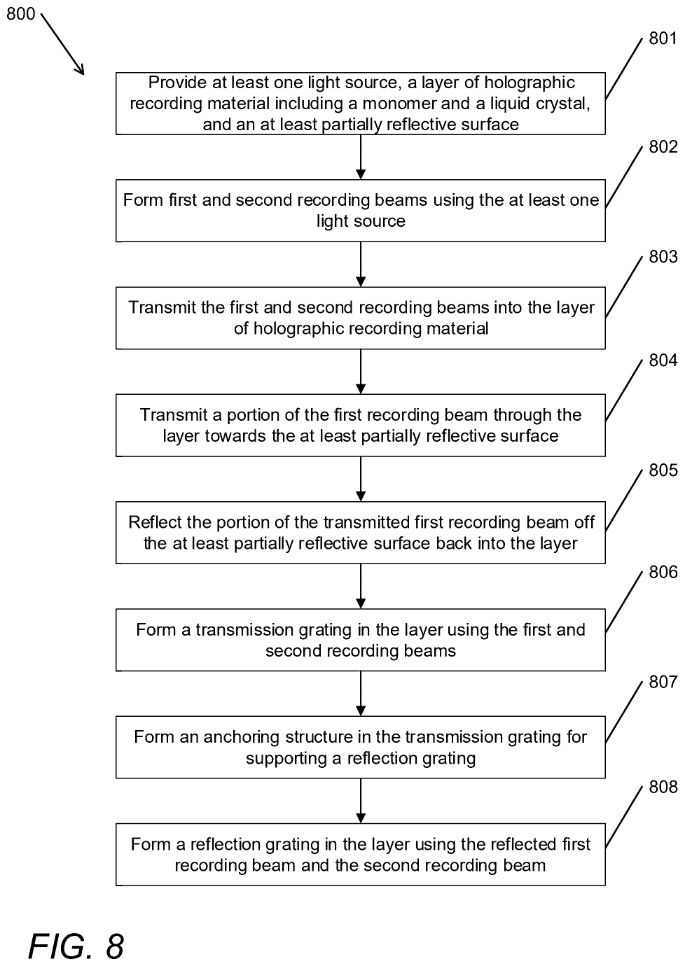

FIG. 8 shows a flow diagram conceptually illustrating a second method of fabricating transmission and reflection gratings in accordance with an embodiment of the invention. As shown, the method 800 includes providing (801) at least one light source, a layer of holographic recording material that includes a monomer and a liquid crystal, and an at least partially reflective surface. First and second recording beams can be formed (802) using the at least one light source. The first and second recording beams can be transmitted (803) into the layer of holographic recording material. A portion of the first recording beam can be transmitted (804) through the layer of holographic recording material towards the reflective surface. A portion of the transmitted first recording beam can be reflected (805) off the reflective surface back into the layer of holographic recording material. A transmission grating can be formed (806) in the layer of holographic recording material using the first and second beams. A liquid crystal to polymer anchoring structure can be formed (807) in the transmission grating for supporting a reflection grating. A reflection grating can be formed layer of holographic recording material (808) using the reflected first beam and the second beam.

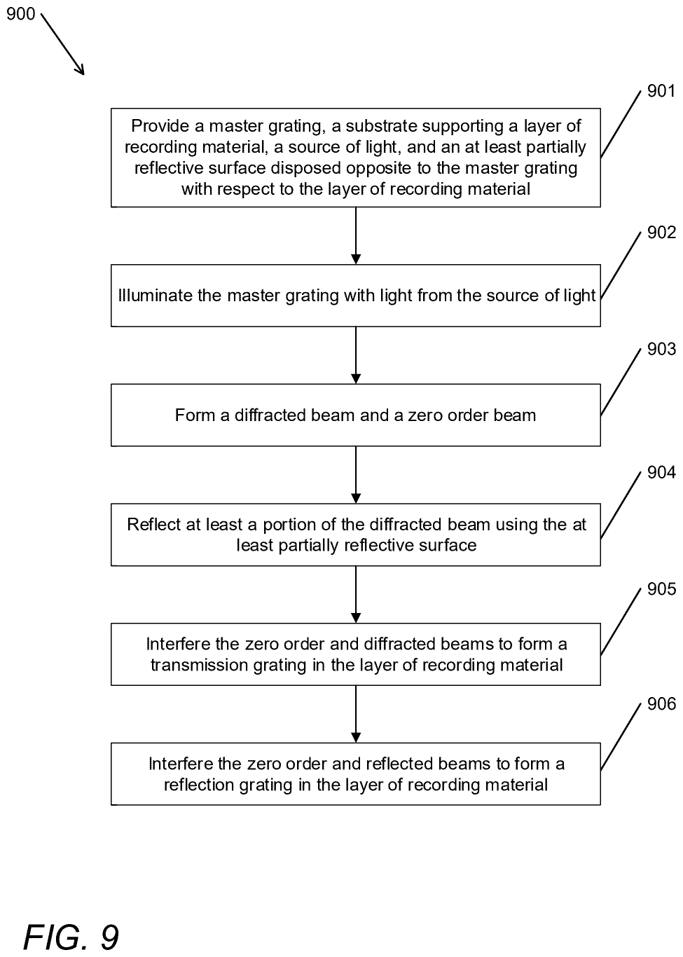

FIG. 9 shows a flow diagram conceptually illustrating a third method of fabricating transmission and reflection gratings in accordance with an embodiment of the invention. As shown, the method 900 includes providing (901) a master grating, a substrate supporting a layer of recording material, a source of light, and an at least partially reflective surface disposed opposite to the master grating with respect to the layer of recording material (i.e., the layer of recording material is between the at least partially reflective surface and the master grating). The master grating can be illuminated (902) with light from the source of light. A diffracted beam and a zero-order beam can be formed (903) from the illumination of the master grating. At least a portion of the diffracted beam can be reflected (904) from the at least partially reflective surface. The zero-order and diffracted beams can be interfered (905) to form a transmission grating in the layer of recording material. The zero-order and reflected beams can be interfered (906) to form a reflection grating in the layer of recording material. As can readily be appreciated, the systems and components implementing the processes described in FIGS. 8 and 9 can be implemented similarly to those described in FIG. 7. For example, holographic recording materials can be similarly substituted among the processes.

Although FIGS. 7-9 illustrate specific methods for forming gratings in a waveguide display, many different processes can be implemented to form such gratings as appropriate depending on the specific requirements of a given application. Furthermore, various modifications can be made to the methods shown in FIGS. 7-9. For example, the transmission and reflection gratings can be formed as multiplexed gratings. In some embodiments, multiplexed transmission and reflection gratings can be formed by interfering the zero order and diffracted light and interfering the reflection of the diffracted light from the partially reflective surface with the zero-order light. In other embodiments, the reflection of the zero-order light and the diffracted light are interfered to form the grating. The transmission and reflection gratings can also be formed across different grating layers.

Waveguides implementing transmission and reflection gratings in accordance with various embodiments of the invention can be implemented with a variety of grating configurations. In many embodiments, the waveguide supports at least one input transmission grating, at least one fold transmission grating, and at least one output transmission grating. At least one of the input, fold, and output transmission gratings can be multiplexed with a reflection grating. In other embodiments, the reflection grating overlaps at least one of the input and fold gratings. In some embodiments, the waveguide supports first and second fold transmission gratings. The first and the second fold transmission gratings can overlap each other and at least one reflection grating. In a number of embodiments, the first and second fold transmission gratings have crossed K-vectors. Each of the fold transmission gratings can be configured to beam-expand light from the input grating in a first direction and couple it towards the other fold transmission grating, which can then beam-expand the light in a different direction and extract it towards a viewer.

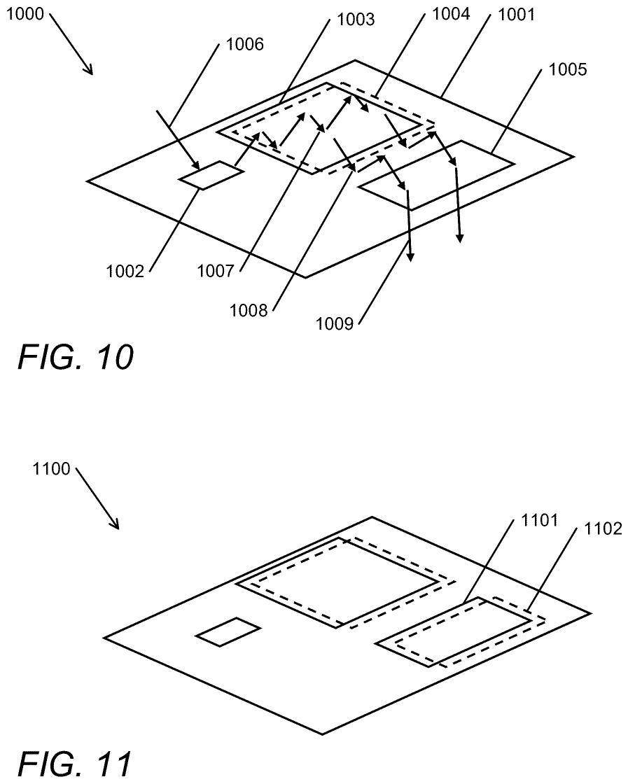

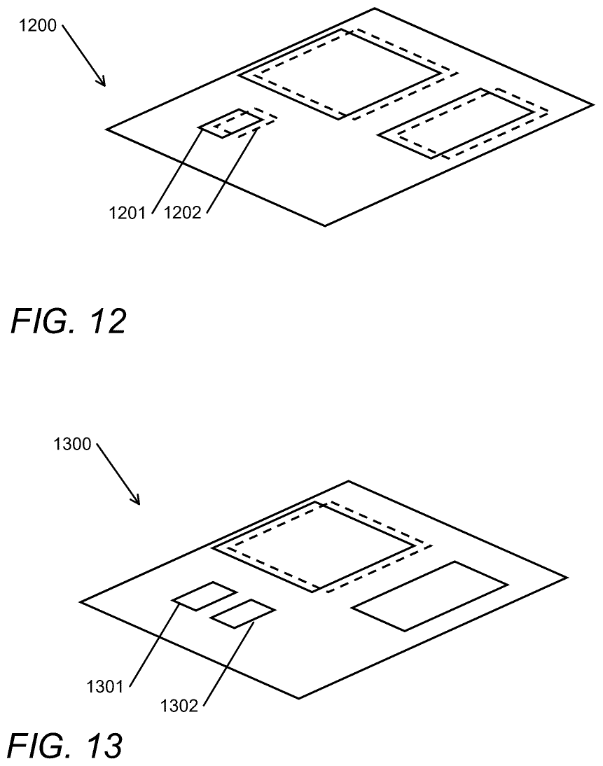

FIG. 10 conceptually illustrates a waveguide display architecture implementing multiplexed transmission and reflection fold gratings in accordance with an embodiment of the invention. In the illustrative embodiment, the waveguide display 1000 includes a waveguide 1001 supporting an input grating 1002, multiplexed transmission 1003 and reflection 1004 gratings, and an output grating 1005. Optical paths for input light 1006, waveguided light 1007, first direction beam-expanded light 1008, and second direction beam-expanded output light 1009 are illustrated. In some embodiments, the grating structures are configured to input and output the light on the same side. As can be readily appreciated, additional embodiments of the invention can include various grating configurations. For example, FIG. 11 conceptually illustrates a waveguide architecture 1100 in which the output grating includes multiplexed transmission 1101 and reflection 1102 gratings while FIG. 12 conceptually illustrates a waveguide architecture 1200 in which the input grating includes multiplexed transmission 1201 and reflection 1202 gratings. FIG. 13 conceptually illustrates a waveguide architecture 1300 in which there are provided two separate input gratings 1301, 1302 in accordance with an embodiment of the invention.

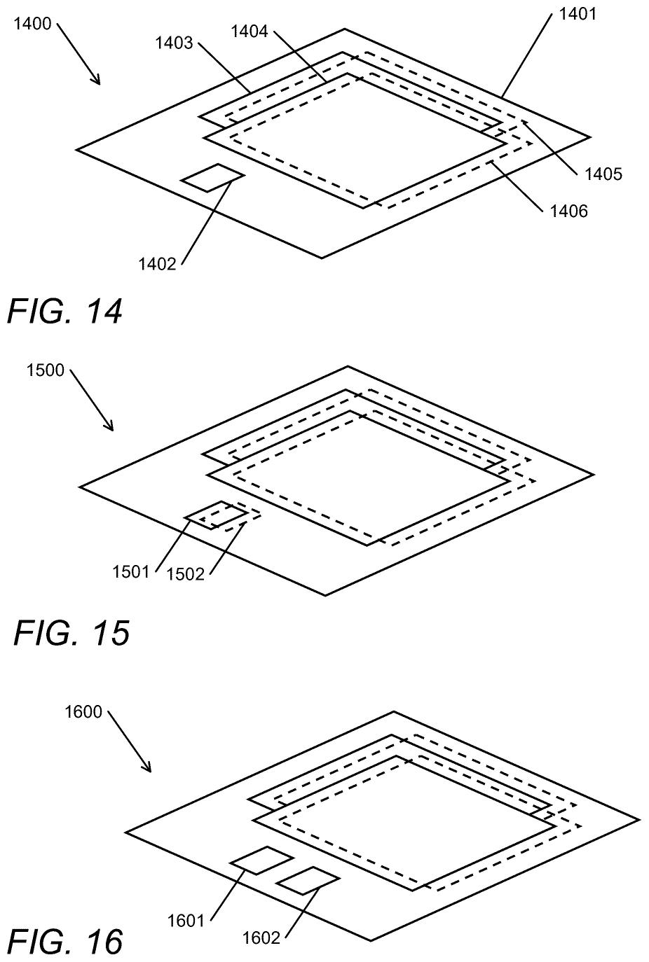

Some key problems in conventional waveguide architectures based on input, fold, and output gratings can be addressed by combining the functions of the fold and output gratings. In many embodiments, the display includes a waveguide supporting an input grating and two overlapping gratings that perform the dual function of expansion and extraction, with each of the overlapped gratings performing either vertical expansion or horizontal expansion according to the field of portion being propagated through waveguide. The grating vectors of the input and overlapped gratings can be arranged in either equilateral or symmetrical configurations to provide substantially zero resultant vector. FIG. 14 conceptually illustrates a waveguide architecture 1400 that includes a waveguide 1401 supporting an input grating 1402 and a grating structure that includes overlapping multiplexed transmission gratings 1403, 1404 and reflection gratings 1405, 1406 in accordance with an embodiment of the invention. In many embodiments, each set of multiplexed gratings are disposed in a different grating layer. In some embodiments, the two sets are further multiplexed with one another, forming four multiplexed gratings. In the embodiment of FIG. 14, the two of the gratings can be configured as crossed fold gratings (i.e., fold gratings with K-vectors in different directions) to provide beam expansion by changing the direction of the guided beam in the plane of the waveguide. In a more general sense, the crossed fold gratings can perform two-dimensional beam expansion and extraction of light from the waveguide. In some embodiments, the transmission gratings are configured as crossed fold gratings. In a number of embodiments, two sets of crossed fold gratings are implemented. The transmission gratings can form one set while the reflection gratings form the second set. In other embodiment, one of each of the transmission gratings and reflection gratings form a set of crossed fold gratings. The field-of-view coupled into the waveguide can include first and second portions. In many embodiments, the first and second field-of-view portions correspond to positive and negative angles vertically or horizontally. In some embodiments, the first and second portions may overlap in angle space. In several embodiments, the first portion of the field-of-view is expanded vertically by the first fold and, in a parallel operation, expanded horizontally and extracted by the second fold.

Although FIG. 14 illustrate a specific grating configuration implementing crossed fold gratings, various other architectures can be utilized as appropriate depending on the requirements of a given application. For example, various different input grating configurations can be utilized. In some embodiments, a prism is utilized instead of an input grating. Other input configurations are shown in FIGS. 15 and 16. FIG. 15 conceptually illustrates a waveguide architecture 1500 using crossed fold gratings in which the input coupler multiplexes transmission 1501 and reflection 1502 gratings in accordance with an embodiment of the invention. FIG. 16 conceptually illustrates a waveguide architecture 1600 using crossed fold gratings in which two separate input coupling gratings 1601, 1602 are provided in accordance with an embodiment of the invention. As can readily be appreciated, it should be apparent that many other combinations of multiplexed transmission and reflection gratings could be used in a waveguide display that provides two-dimensional beam expansion. In some embodiments, one of the reflection gratings can be omitted from the set of multiplexed gratings used in the crossed grating structure.

In many embodiments, the apparatus includes a waveguide in which input light is split into two wavelength bands, which follow bifurcated paths each with a dedicated fold grating. Light can be extracted using a pair of overlapping output gratings with one grating allocated to each wavelength band. The output gratings can have gratings vectors at 90 deg. to each other. The gratings can use of surface relief or holographic type. In many embodiments, the apparatus includes a waveguide supporting overlapping diffractive elements with grating vectors aligned in the same direction for performing horizontal expansion and extraction. The gratings can sandwich an electro active material enabling switching between clear and diffracting states. With regard to crossed grating waveguide architectures, the present disclosure can incorporate the embodiments and teachings disclosed in U.S. patent application Ser. No. 16/709,517 entitled “Methods And Apparatuses For Providing A Single Grating Layer Color Holographic Waveguide Display” and U.S. patent application Ser. No. 14/620,969 entitled “Waveguide Grating Device,” the disclosures of which are incorporated herein by reference in their entireties for all purposes.

The prescriptions and material properties can be determined by reverse ray tracing from the eye box to the image source. The grating layer can be supported by a transparent substrate. The substrates can be a high index material, optical glass or plastic. In some embodiments, the substrate is curved. The grating can be covered by a second substrate, the first and second substrates forming a light guiding structure. The grating can be divided into separate grating elements each have different material and grating properties. At least some of grating elements can be electrically switchable. The gratings can be formed in a holographic photopolymer, a HPDLC material system, uniform modulation HPDLC material system, or any other material systems that includes at least one LC and one polymer component. The material or grating properties can vary in step change or may vary continuously. The multiplexed transmission and reflection gratings can have prescriptions optimized for the purpose of propagating image light of different wavelength bands, light of different angular bandwidths, and light of different polarizations. The gratings can be formed using an inkjet deposition process.

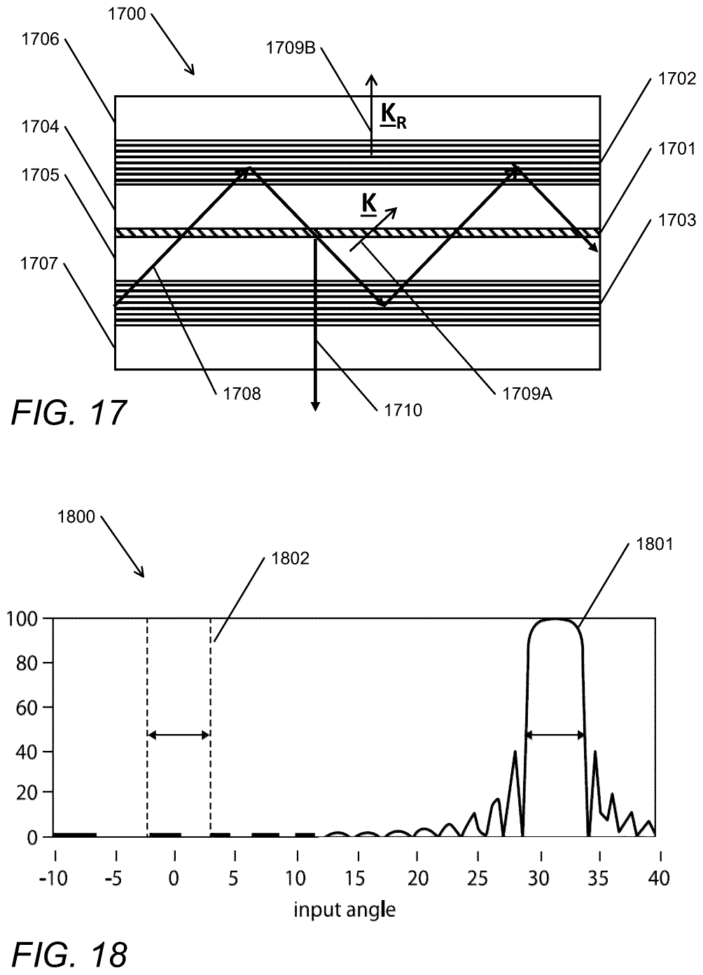

FIG. 17 conceptually illustrates a profile view of a waveguide architecture 1700 in which overlapping transmission 1701 and reflection gratings 1702, 1703 are provided in accordance with an embodiment of the invention. In the illustrative embodiment, the architecture 1700 includes a transmission grating 1701 sandwich by substrates 1704, 1705, each substrate having an outer surface in contact with one of the reflection gratings 1702, 1703. The outer surface of each reflection grating is in contact with a substrate 1706, 1707. As shown, the transmission 1701 and reflection 1702, 1703 gratings are disposed in separate layers. As can readily be appreciated, all or any combination of the gratings can be multiplexed. As described in the sections above, the gratings can be used to provide input coupling, beam expansion, and/or beam extraction. Light propagation in the waveguide is schematically represented by ray 1708. The transmission grating K-vectors (labelled by symbol K and numeral 1709A) are slanted. The reflection grating Bragg fringes are substantially unslanted with K-vectors labelled by symbol KR and numeral 1709B. Light extraction from the waveguide is represented by the ray 1710.

The reflection holograms can be essentially considered stratified index systems. In many embodiments, the outer layers of the reflection gratings can provide environmental isolation by attenuating the guided beam so that total internal reflection occurs mainly before the light hits the outer surfaces of the waveguide. In some embodiments, aberration can be corrected by building compensation functions into the transmission grating and reflection grating prescriptions. Reflective holographic optical elements (R-HOEs) may also enable curved waveguides. FIG. 18 shows a chart 1800 illustrating the diffraction efficiency versus incidence angle of a reflection grating 1801 and the diffraction efficiency angular bandwidth of a transmission grating 1802 in accordance with an embodiment of the invention. Typically, the reflection grating has a diffraction efficiency angular bandwidth of around 5-6°. In many embodiments, a reflection grating recorded in HPDLC can be configured to be polarization selective. In several embodiments, the upper and lower reflection gratings can have symmetric prescriptions.

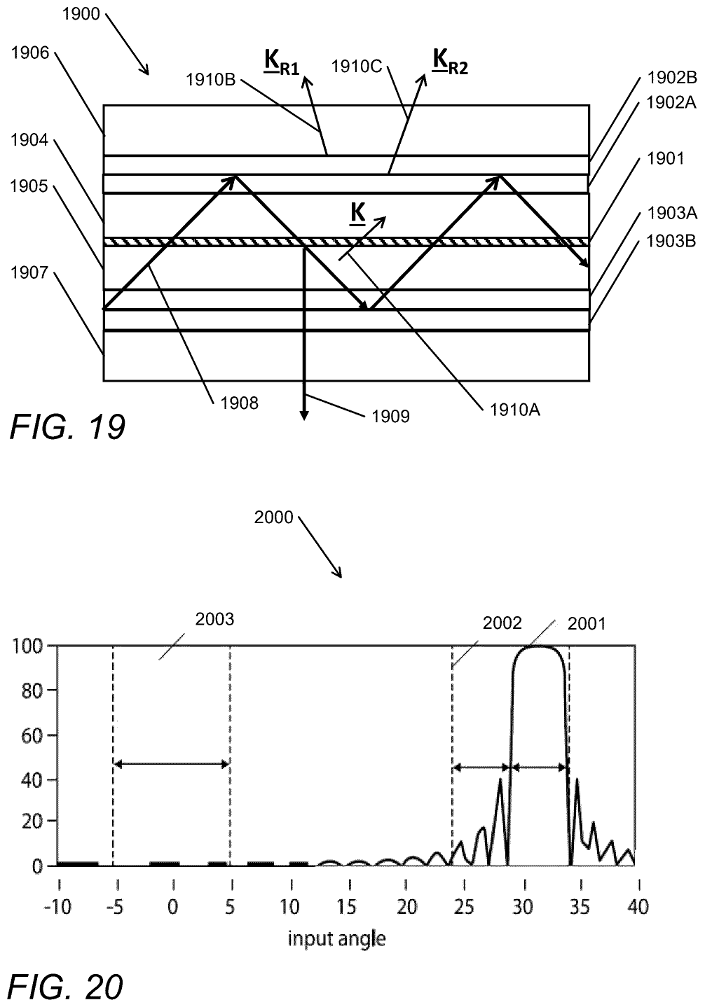

In some embodiments, the waveguide angular bandwidth can be expanded by using two reflection gratings disposed above and below the transmission grating. FIG. 19 conceptually illustrates a profile view of a waveguide architecture 1900 in which overlapping transmission 1901 and reflection gratings 1902A, 1902B, 1903A, and 1903B are provided in accordance with an embodiment of the invention. Again, although the drawings illustrate reflection and transmission gratings disposed in separate layers, all or any combination of the gratings can be multiplexed. In the illustrative embodiment, the architecture 1900 includes a transmission grating 1901 sandwich by substrates 1904, 1905, each substrate having an outer surface in contact with one of the reflection gratings 1902A, 1903A. The outer surface of the outer reflection grating 1902B, 1903B of each of the upper and lower pairs is in contact with a substrate 1906, 1907. Light propagation in the waveguide is schematically represented by ray 1908, and extracted light is schematically represented by ray 1909. The transmission grating K-vectors (labelled by symbol K and numeral 1910A) are slanted while the reflection grating K-vectors (labelled by symbol K_{R1} and numeral 1910B and symbol K_{R2} and numeral 1910C) are substantially unslanted. FIG. 20 is a chart 2000 illustrating the diffraction efficiency versus incidence angle of the reflection grating 2001, the effective angular bandwidth resulting from the two reflection gratings 2002, and the diffraction efficiency angular bandwidth of the transmission grating 2003.

In some embodiments, the apparatus includes at least one grating with spatially varying pitch. In some embodiments, each grating has a fixed K vector. In many embodiments, at least one of the gratings is a rolled k-vector grating according to the embodiments and teachings disclosed in the cited references. Rolling the K-vectors allows the angular bandwidth of the grating to be expanded without the need to increase the waveguide thickness. In some embodiments, a rolled K-vector grating includes a waveguide portion containing discrete grating elements having differently aligned K-vectors. In some embodiments, a rolled K-vector grating includes a waveguide portion containing a single grating element within which the K-vectors undergo a smooth monotonic variation in direction. In some of the embodiments, describe rolled K-vector gratings are used to input light into the waveguide.

In some embodiments directed at displays using unpolarized light sources, the input gratings used in the invention combine gratings orientated such that each grating diffracts a particular polarization of the incident unpolarized light into a waveguide path. Such embodiments may incorporate some of the embodiments and teachings disclosed in the PCT application PCT/GB2017/000040 “Method and Apparatus for Providing a Polarization Selective Holographic Waveguide Device,” the disclosure of which is incorporated herein by reference in its entirety for all purposes. The output gratings can be configured in a similar fashion so the light from the waveguide paths is combined and coupled out of the waveguide as unpolarized light. For example, in some embodiments the input grating and output grating each combine crossed gratings with peak diffraction efficiency for orthogonal polarizations states. In some embodiments, the polarization states are S-polarized and P-polarized. In some embodiments, the polarization states are opposing senses of circular polarization. The advantage of gratings recorded in liquid crystal polymer systems, such as SBGs, in this regard is that owing to their inherent birefringence they exhibit strong polarization selectivity. However, other grating technologies that can be configured to provide unique polarization states may be used.

In some embodiments using gratings recorded in liquid crystal polymer material systems at least one polarization control layer overlapping at least one of the fold gratings, input gratings or output gratings may be provided for the purposes of compensating for polarization rotation in any the gratings, particularly the fold gratings, which the inventors have found may result in polarization rotation. In some embodiments, all of the gratings are overlaid by polarization control layers. In some embodiments polarization control layers are applied to the fold gratings only or to any other subset of the gratings. The polarization control layer may include an optical retarder film. In some embodiments based on HPDLC materials, the birefringence of the gratings may be used to control the polarization properties of the waveguide device. The use of the birefringence tensor of the HPDLC grating, K-vectors and grating footprints as design variables opens up the design space for optimizing the angular capability and optical efficiency of the waveguide device. In some embodiments, a quarter wave plate disposed on a glass-air interface of the waveguide rotates polarization of a light ray to maintain efficient coupling with the gratings. For example, in one embodiment, the quarter wave plate is a coating that is applied to substrate waveguide. In some waveguide display embodiments, applying a quarter wave coating to a substrate of the waveguide may help light rays retain alignment with the intended viewing axis by compensating for skew waves in the waveguide. In some embodiments, the quarter wave plate may be provided as multi-layer coating.

The construction and arrangement of the systems and methods as shown in the various exemplary embodiments are illustrative only. Although only a few embodiments have been described in detail in this disclosure, many modifications are possible (for example, variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

1. (canceled)

2. A waveguide display, comprising:
a source of light modulated with image data;
at least one transmission grating;
at least one reflection grating, wherein the at least one transmission grating and the at least one reflection grating at least partially overlap, wherein the at least one partially overlapping at least one transmission grating and at least one reflection grating provide an evanescently coupled layer in proximity to a waveguide; and
at least one input coupler for coupling light from said source of light into a total internal reflection (TIR) path in the waveguide towards the at least partially overlapping at least one transmission grating and at least one reflection grating;
wherein the at least one transmission grating and the at least one reflection grating provide beam expansion of light from the input coupler in at least two directions and extract light from the input coupler out of the waveguide towards a viewer.

3. The waveguide display of claim 2, wherein the evanescently coupled layer comprises a grating structure comprising an HPDLC comprising a liquid crystal rich region and a liquid crystal poor region.

4. The waveguide display of claim 3, wherein the evanescently coupled layer comprises a surface relief structure formed by at least partially extracting liquid crystals from the HPDLC grating structure.

5. The waveguide display of claim 4, wherein the surface relief structure is at least partially backfilled with material, wherein the material has a higher refractive index or a lower refractive index than the liquid crystal poor region.

6. The waveguide display of claim 2, wherein at least one of the at least one transmission grating and at least one reflection grating is a Switchable Bragg Grating (SBG) structure, wherein the SBG structure can be in a passive mode.

7. The waveguide display of claim 2, wherein the at least one input coupler is a grating.

8. The waveguide display of claim 2, wherein the at least one transmission grating comprises a fold transmission grating; and
wherein the at least one fold transmission grating is multiplexed with the at least one reflection grating.

9. The waveguide display of claim 2, wherein:
the at least one input coupler comprises an input transmission grating;
the at least one transmission grating comprises at least a first fold transmission grating and a second fold transmission grating, wherein the first fold transmission grating and the second fold transmission grating at least partially overlap, wherein the first fold transmission grating and the second fold transmission grating have crossed K-vectors; and
the at least one reflection grating at least partially overlaps at least one of the input transmission grating, the first fold transmission grating, and the second fold transmission grating,
wherein the at least one transmission grating and the at least one reflection grating are provide beam expansion of light from the input coupler in at least two directions and extract light from the input coupler out of the waveguide towards a viewer.

10. The waveguide display of claim 2, wherein each of the gratings has a grating vector that in combination provide a resultant vector with substantially zero magnitude.

11. The waveguide display of claim 2, wherein the light undergoes a dual interaction within at least one of the gratings.

12. The waveguide display of claim 2, further comprising a beam splitter layer overlapping the at least one reflection grating.

13. The waveguide display of claim 2, further comprising an alignment layer overlapping the at least one reflection grating.

14. The waveguide display of claim 2, wherein the source of data modulated light is selected from the group consisting of: a laser-scanning projector, a microdisplay panel, and an emissive display.

15. The waveguide display of claim 2, wherein the source of light provides at least two different wavelengths.

16. The waveguide display of claim 2, wherein at least one of the at least one input coupler, at least one transmission grating, and at least one reflection grating is characterized by a spatial variation of at least one property selected from the group consisting of: refractive index modulation, K-vector, grating vector, grating pitch, and birefringence.

17. The waveguide display of claim 2, wherein at least one of the at least one input coupler, at least one transmission grating, and at least one reflection grating is configured to provide a plurality of separate optical paths for at least one property selected from the group consisting of: wavelength band, angular bandwidth, and polarization state.

18. The waveguide display of claim 2, wherein the waveguide is curved.

19. The waveguide display of claim 2, wherein the waveguide incorporates a GRIN structure.

20. The waveguide display of claim 2, wherein at least one of the at least one input coupler, at least one transmission grating, and at least one reflection grating comprises a grating structure selected from the group consisting of: a switchable Bragg grating (SBG) recorded in a holographic photopolymer and a HPDLC material, a SBG recorded in a uniform modulation holographic liquid crystal polymer material, a Bragg grating recorded in a photopolymer material, and a surface relief grating.
